(19) United States
(12) Patent Application Publication
(10) Pub. No.: US 2026/0250910 A1
(43) Pub. Date: Aug. 27, 2026

(54) A METHOD FOR PRODUCING A LAMINATE, AND A LAMINATE

(71) Applicant: Stora Enso OYJ, Helsinki (FI)

(72) Inventors: Otto Nylén, Helsinki (FI); Isto Heiskanen, Imatra (FI); Kaj Backfolk, Lappeenranta (FI); Jukka Kankkunen, Imatra (FI)

(73) Assignee: Stora Enso OYJ, Helsinki (FI)

(21) Appl. No.: 18/877,514

(22) PCT Filed: Jun. 29, 2023
(86) PCT No.: PCT/IB2023/056759

§ 371 Date: Dec. 20, 2024

(30) Foreign Application Priority Data
Jul. 8, 2022 (SE) 2230233-5

(51) Int. Cl. D21H 19/34; D21H 23/64

(52) U.S. Cl. CPC D21H 19/34; D21H 23/64

(57) ABSTRACT

The present invention relates to a method for producing a laminate (8) comprising a paper substrate and a microfibrillated cellulose (MFC) layer. An MFC suspension comprising 50-100 weight-% of MFC is provided. A wet MFC layer (1) is formed by casting the suspension on a metal belt support (2), wherein the formed wet MFC layer (1) has a dry content of 1-40 weight-%. A paper substrate having a Gurley Hill air permeability value of less than 10000 s/100 ml is provided and joined with the wet MFC layer (1) positioned on the metal belt support (2) to form a laminate structure (6). The laminate structure (6) positioned on the metal belt support (2) is subjected to water removal to form the laminate (8). The water removal comprises at least one drying step which comprises drying by at least one non-contact drying device (7), wherein the metal belt support (2) is heated during the at least one drying step. The invention relates also to a laminate (8) and a packaging material comprising the laminate (8).

### TECHNICAL FIELD

The present disclosure relates to a method for producing a laminate comprising a paper substrate and a barrier layer, wherein the barrier layer is a microfibrillated cellulose (MFC) layer and wherein the laminate has good barrier properties, such as oxygen barrier properties and water vapor barrier properties, and good adhesion between the paper substrate and the barrier layer. In addition, the present disclosure relates to a laminate comprising a paper substrate and an MFC layer, a packaging material comprising the laminate and use of the laminate in a packaging material.

### BACKGROUND

Oxygen, grease, water vapor and/or aroma barrier properties are required in many uses of paper packaging. However, paper does not have these properties inherently. Most commonly, barrier characteristics of a paper substrate are created by adding one or more barrier coatings and/or laminated barrier layers which are based on plastics or other non-renewable materials. The disadvantage with these coatings and barrier layers is their non-renewable raw material basis that can increase the carbon dioxide footprint of the material as well as make the otherwise biodegradable paper non-biodegradable and in some cases non-recyclable. Furthermore, in order to improve a barrier comprising barrier coatings and/or laminated barrier layers based on plastics or other non-renewable materials, it is usually needed to increase the amount of used polymer and/or various polymer layers. Hence, the possibility to disintegrate and recycle fiber fraction(s) of paper substrates provided with such improved barriers becomes then even more difficult. Also, in case of lamination, an adhesive might be needed to tie the barrier layer to paper to form a laminate, which further increases the amount and number of non-renewable and/or non-recyclable components in the package laminate.

More recently, microfibrillated cellulose (MFC) films and coatings have been developed, in which cellulosic fibrils, provided by fibrillation of cellulose fibers, have been suspended e.g., in water and thereafter re-organized and re-bonded together to form a dense, transparent or translucent film or coating with barrier properties, such as oxygen, water vapor and oil/grease barrier properties. MFC films and coatings are recyclable and biodegradable as well as based on renewable raw material. Often, MFC films and coatings require additives such as film forming agents, dispersants, plasticizers, softeners, rheology modifiers and/or mineral fillers. Retention of these additives in the MFC film or coating is important.

In order to provide a paper substrate with an MFC film, a free-standing MFC film may be produced from an MFC suspension and thereafter laminated with the paper substrate using, for example, one or more adhesive layers.

One approach to produce a free-standing MFC film from an MFC suspension is to use a film casting method, i.e., forming a film by casting the MFC suspension on a non-porous support, such as a plastic or metal support, and then dewatering and/or drying the film. Casting methods have been shown to produce MFC films with very smooth surfaces with good barrier properties, such as oxygen barrier properties and/or water vapor barrier properties.

Another approach to produce a free-standing MFC film from an MFC suspension is to use a wet laid technique, i.e., to apply a layer of an MFC suspension on a dewatering wire or membrane and dewater it by vacuum and/or gravitation and/or capillary dewatering and/or press dewatering on the wire or membrane. However, one disadvantage with this approach is that film additives that are either dissolved or emulsified in the aqueous phase of the MFC suspension are removed from the MFC layer to a large extent during the dewatering. Retention and/or flocculation agents may thus be needed to counteract removal of film additives. However, retention and/or flocculation agents usually have a negative impact on barrier properties and do not guarantee complete retention. Also, this approach has limitations for the used MFC type, as very fine MFC cannot be used as it can also pass or penetrate through the wire or clog the wire or membrane during dewatering. Also, other very small dissolved or solid particles dispersed in aqueous phase of MFC suspension, such as mineral fillers, have tendency to pass and penetrate through the wire or membrane in dewatering steps.

Free-standing MFC films produced by a casting method or a wet-laid method have low resilience, which may lead to web handling difficulties in lamination. Furthermore, the lamination of the free-standing MFC film to the paper substrate requires an adhesive that ties the MFC film to the paper substrate.

Alternatively, an MFC coating or barrier layer may be produced directly onto a paper substrate by applying an MFC suspension on the paper substrate by a coating technique such as e.g., size press or film press, spraying, blade coating, rod coating or curtain coating. However, applying an MFC suspension on a paper substrate by a coating technique may be difficult due to high viscosity of the MFC suspension. Also, a substantial amount of water is added, which makes the coating process very difficult, in particular for low grammage substrates.

Thus, there is still room for improvements of methods for producing laminates comprising a paper substrate and a barrier layer, wherein the barrier layer is an MFC layer.

### DESCRIPTION OF THE INVENTION

It is an object of the present invention to provide an improved method for producing a laminate comprising a paper substrate and a barrier layer, wherein the barrier layer is an MFC layer and wherein the laminate has good barrier properties, such as oxygen barrier properties and water vapor barrier properties, and good adhesion between the paper substrate and the barrier layer, which method eliminates or alleviates at least some of the disadvantages of the prior art methods.

The above-mentioned object, as well as other objects as will be realized by the skilled person in the light of the present disclosure, is achieved by the various aspects of the present disclosure.

The invention is defined by the appended independent claims. Embodiments are set forth in the appended dependent claims and in the following description.

According to a first aspect illustrated herein, there is provided a method for producing a laminate comprising a paper substrate and a microfibrillated cellulose (MFC) layer, wherein the method comprises the steps of:
providing an MFC suspension comprising between 50 weight-% to 100 weight-% MFC based on total dry weight and a suspension medium;
forming a wet MFC layer by casting said MFC suspension on a casting surface of a metal belt support, wherein said formed wet MFC layer has a dry content of 1-40 weight-%, preferably 2-25 weight-%, more preferably 3-15 weight-%, most preferably 3.5-8 weight-%, and wherein said formed wet MFC layer is formed of an amount of said MFC suspension corresponding to a dry grammage of 8-70 g/m², preferably 10-50 g/m², most preferably 15-40 g/m²;
providing a paper substrate web, wherein said paper substrate of said paper substrate web has a Gurley Hill air permeability value of less than 10000 s/100 ml, preferably less than 5000 s/100 ml, more preferably less than 1000 s/100 ml, as measured according to standard ISO 5636-5:2013;
joining said paper substrate web with said wet MFC layer positioned on said casting surface of said metal belt support to form a laminate structure positioned on said casting surface of said metal belt support, wherein said wet MFC layer has a dry content of 1-40 weight-%, preferably 2-25 weight-%, more preferably 3-15 weight-%, most preferably 3.5-8 weight-%, and said paper substrate web has a dry content of at least 70 weight-%, preferably at least 80 weight-%, most preferably at least 85 weight-%, when said paper substrate web is joined with said wet MFC layer;
subjecting said laminate structure to water removal to form said laminate comprising said paper substrate and said MFC layer, wherein said formed laminate has an average dry content of at least 80 weight-%, wherein said laminate structure is positioned on said casting surface of said metal belt support during the water removal, wherein the water removal comprises at least one drying step which comprises subjecting said laminate structure to drying by at least one non-contact drying device arranged on the side of the laminate structure opposite the metal belt support and wherein said metal belt support is heated during said at least one drying step, and
separating said laminate from said metal belt support.

It has surprisingly been found that it is possible to produce a laminate comprising a paper substrate and a barrier layer, wherein the barrier layer is an MFC layer, which laminate has good barrier properties, such as oxygen barrier properties and water vapor barrier properties, and good adhesion between the paper substrate and the MFC layer, by forming a wet MFC layer from an MFC suspension as specified above by casting on a casting surface of a metal belt support and joining the wet MFC layer, with a dry content as specified above, with a paper substrate web, with an air permeability and a dry content as specified above, before removing water from the laminate structure by drying of the laminate structure using non-contact drying equipment positioned on the side of the laminate structure opposite the metal belt support in combination with contact drying by heating of the metal belt support, wherein the MFC layer is kept on the casting surface of the metal belt support, on which it was formed, during the joining step and the water removal.

In particular, it has surprisingly been found that it is possible to dry the wet MFC layer of the laminate structure positioned on the casting surface of the metal belt support, i.e., positioned between the metal belt support and the paper substrate, by using non-contact drying equipment positioned on the side of the laminate structure opposite the metal belt support and contact drying by heating of the metal belt support according to the first aspect of the present disclosure. Thus, it has been surprisingly found that it is possible to dry the wet MFC layer, which contains a relatively high amount of water, by water and water vapor penetrating through the paper substrate by the use of non-contact drying equipment in combination with contact drying by heating of the metal belt support.

Also, by using a combination of non-contact drying equipment on one side of the laminate structure and contact drying equipment (i.e., the heated metal belt support) on the other side of the laminate structure, it is possible to dry the wet MFC layer of the laminate structure efficiently. The non-contact drying equipment efficiently removes water and water vapor from the side of the laminate structure opposite the metal belt support and the heating of the metal belt support increases the drying rate, i.e., the penetration of water and water vapor through the paper substrate. The efficient drying enables that an MFC layer, which has a thickness needed to create good barrier properties, may be provided on the paper substrate in a production efficient way.

By laminating a wet MFC layer with a paper substrate web and thereafter drying the laminate structure according to the first aspect of the present disclosure, difficulties of handling free-standing dry MFC films having low resilience in lamination processes with paper substrates are avoided.

Furthermore, it has surprisingly been found that it is possible to obtain a strong adhesion of the MFC layer to the surface of the paper substrate by using the method according to the first aspect of the present disclosure. Without being bound to any theory, it is believed that the strong adhesion is due to mechanical interlocking of fibers and fibrils, ionic interactions and/or other type of intermolecular interaction. Thus, the need of using adhesive between the paper substrate and the MFC layer is reduced or eliminated.

By using the method according to the first aspect of the present disclosure, the laminate may be produced in an efficient way since the MFC layer is kept on the casting surface of the metal belt support from casting until after drying when it is separated or peeled off from the metal belt support. The fact that the MFC layer is formed and retained on the casting surface of the metal belt support until after drying enables that also the material efficiency and retention of smallest fibril fractions and e.g., nanofillers and water soluble additives, if present, in the MFC layer is facilitated, and that the use of retention and/or flocculation drainage agents in the MFC suspension is reduced or eliminated. Smallest fibril fractions contribute to barrier properties positively. Also, the retention of additives is an advantage compared to wire dewatering in which the retention of water soluble additives is limited. In addition, the side of the MFC layer being in contact with the metal belt support may be provided with a high smoothness and uniformity. The use of the metal belt support is also advantageous for the dimensional stability of the MFC layer, for example due to adhesion of the MFC layer to the metal belt support. Furthermore, an advantage of the method of the first aspect is that curl may be at least substantially eliminated or controlled due to restrained drying and restrained optional dewatering since the MFC layer is kept on the casting surface of the metal belt support from casting until after drying.

Also, the method according to the first aspect implies that a laminate having good barrier properties, such as oxygen barrier properties and water vapor barrier properties, can be manufactured almost entirely from biobased materials, and preferably from cellulose based materials, thereby facilitating recycling of the used laminate, enabling provision of a barrier substrate that can be considered as a mono-component substrate (<5% of other additives or plastic) and enabling reduction of the carbon dioxide footprint. The laminate may also have good oil, grease and/or aroma barrier properties.

As mentioned above, the method of the first aspect of the present disclosure comprises a step of providing an MFC suspension comprising between 50 weight-% to 100 weight-% MFC based on total dry weight of the MFC suspension. The MFC suspension comprises a suspension medium in which a mixture of cellulose-based material and optional further components and/or additives are suspended. Preferably, the MFC suspension is an aqueous suspension comprising a water-suspended mixture of cellulose-based material and optional further components and/or additives.

Microfibrillated cellulose (MFC) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by oxidation, for example 2,2′,6,6′-tetramethylpiperidin-N-oxyl (TEMPO) mediated oxidation), or quaternary ammonium (cationic cellulose). After being modified or oxidized in one of the above-described methods, it is easier to disintegrate the fibers into MFC.

MFC can be produced from wood cellulose fibers, both from hardwood and/or softwood fibers. It can also be made from microbial sources, agricultural fibers such as wheat straw pulp, bamboo, bagasse, or other non-wood fiber sources. It can be made from pulp, including pulp from virgin fiber, e.g., mechanical, chemical and/or thermomechanical pulps. It can also be made from broke or recycled paper.

As mentioned above, the MFC suspension used in the method of the first aspect comprises between 50 weight-% to 100 weight-% of MFC based on total dry weight. In some embodiments, the MFC suspension comprises between 60 weight-% to 100 weight-%, preferably between 70 weight-% to 100 weight-%, more preferably between 80 weight-% to 100 weight-% of MFC based on total dry weight. The MFC layer of the laminate produced by the method of the first aspect may comprise between 50 weight-% to 100 weight-%, such as between 60 weight-% to 100 weight-%, preferably between 70 weight-% to 100 weight-%, more preferably between 80 weight-% to 100 weight-% of MFC based on total dry weight, wherein this relates to the amount of MFC in the MFC layer per se.

The MFC of the MFC suspension may comprise one or more fractions of MFC. In some embodiments, the MFC of the MFC suspension comprises one fraction of MFC of a fine grade. In some embodiments, the MFC of the MFC suspension comprises two or more fractions of MFC of different fine grades. In some embodiments, the MFC of the MFC suspension comprises one fraction of a fine grade and one fraction of a coarse grade, wherein the coarse grade for example may be an additive. Coarse MFC in this case has typically a Schopper-Riegler value of 80-100 SR°, such as 80-99 SR° or 90-99 SR° or 95-99 SR°, whereas fine MFC is fibrillated to a Schopper-Riegler value above the measurement range (theoretical value about or above 100 SR°) as determined by standard ISO 5267-1. In some embodiments, the fine grade MFC is chemically derivatized, such as carboxymethylated MFC.

The MFC suspension may in addition to MFC comprise any conventional paper making additives or chemicals such as film-forming agents, dispersants, fillers, pigments, wet strength chemicals, cross-linkers, plasticizers, softeners, humectants, adhesion primers, wetting agents, biocides, colorants, de-foaming chemicals, hydrophobizing chemicals such as alkyl ketene dimer (AKD), alkenyl succinic anhydride (ASA), waxes, rosin resins, mineral additives (fillers) such as bentonite, kaolin, talcum, mica, montmorillonite, organoclays, graphene and graphene oxide, stearate, starch, silica, precipitated calcium carbonate, cationic polysaccharide, rheology modifiers, etc. These additives or chemicals may thus be process chemicals or film performance chemicals added to provide the MFC layer of the end product with specific properties and/or to facilitate production of the MFC layer.

In some embodiments, the MFC suspension further comprises at least one additive selected from the group of film forming agents, dispersants, plasticizers, softeners, mineral additives, humectants, cross-linkers, light or UV blockers, lubricants, dyes and rheology modifiers.

In some embodiments, the suspension medium is or comprises water, and the MFC suspension further comprises at least one water-soluble additive. In some embodiments, the suspension medium is or comprises water, and the MFC suspension further comprises at least one water-soluble polymer that can form a film and/or improve binding between cellulose fibrils. Typical examples of such polymers are natural gums or polysaccharides or derivatives thereof such as carboxymethylated cellulose (CMC), starch, or polyvinyl alcohol (PVOH) or derivatives or analogues thereof.

In some embodiments, the suspension medium is or comprises water, and the MFC suspension further comprises at least one water-soluble additive selected from the group of: PVOH and derivatives and analogues thereof, starch, CMC, sorbitol and polyethylene glycol.

The PVOH may be a single type of PVOH, or it can comprise a mixture of two or more types of PVOH, differing e.g., in degree of hydrolysis or viscosity. The PVOH may for example have a degree of hydrolysis in the range of 80-99 mol %, preferably in the range of 88-99 mol %.

Since the MFC layer is formed and retained on the metal belt support, which is a non-porous support, until after drying according to the first aspect of the method, additives, including water-soluble additives, are to a greater extent retained in the layer compared to when a porous support is utilized. Also, additives, in particular water-soluble additives, may be transported to the paper substrate with the water during water removal through the paper substrate and may thereby improve the properties of the paper substrate. In embodiments in which starch is utilized as an additive of the MFC suspension, starch may be transported to the paper substrate, or to the boundary regions between the MFC layer and the paper substrate, with the water during water removal and, thus, promote the adhesion between the formed MFC layer and the paper substrate.

In some embodiments, the MFC suspension is free of retention agents and flocculation agents. Since the MFC layer is formed and retained on the metal belt support, which is a non-porous support, until after drying according to the first aspect of the method, the need of retention and/or flocculation agents may be reduced or eliminated.

In some embodiments, the MFC suspension comprises no more than 50 weight-%, such as no more than 40 weight-% or no more than 30 weight-% or no more than 25 weight-% of additives, based on total dry weight of the MFC suspension. For example, the MFC suspension may comprise 1-50 weight-% or 1-40 weight-% or 1-30 weight-% or 1-25 weight-% of additives, based on total dry weight of the MFC suspension.

In some embodiments, the MFC suspension comprises 0.5-20 weight-% of a plasticizing agent based on total dry weight, such as sorbitol, glycol or other polyol.

In some embodiments, the MFC suspension comprises up to 20% of mineral filler (regular filler or nanofiller), such as bentonite, kaolin, talcum, mica, montmorillonite, organoclays, graphene, graphene oxide, non-flaky minerals, such as calcium carbonate (PCC or GCC), silicon dioxide or gypsum, or a combination thereof.

As mentioned above, the method of the first aspect comprises a step of forming a wet MFC layer on, such as on top of, a casting surface of a metal belt support. The wet MFC layer is formed on the casting surface of the metal belt support by casting, such as cast coating, the MFC suspension onto the metal belt support.

The term “casting”, when utilized in film-forming or forming of a layer, is a known term designating methods wherein a suspension is deposited by means of contact or non-contact deposition and levelling methods on a support, typically an endless support, to form a wet web or layer. Examples of such a deposition and levelling method are, curtain coating/application, slot die casting, or dosing of the MFC suspension with spray or similar device and levelling with a doctor blade or rod.

It is important to apply the MFC suspension to the casting surface of the metal belt support in such a way that a homogeneous wet MFC layer is formed, meaning that the wet MFC layer should be as uniform as possible with as even thickness as possible etc. As mentioned above, the formed wet MFC layer is formed of an amount of the MFC suspension corresponding to a dry grammage (basis weight) of 8-70 g/m², such as 9-70 g/m² or 10-70 g/m², preferably 10-50 g/m², most preferably 15-40 g/m². The dry MFC layer is preferably translucent.

According to the method of the first aspect, the formed wet MFC layer has a dry content of 1-40 weight-%, preferably 2-25 weight-%, more preferably 3-15 weight-%, most preferably 3.5-8 weight-%, at formation (i.e., during application on the metal belt support or immediately after application/formation on the metal belt support). Thus, the MFC suspension has a dry content of 1-40 weight-%, preferably 2-25 weight-%, more preferably 3-15 weight-%, most preferably 3.5-8 weight-%.

The metal belt support on which the wet MFC layer is formed is a support in the form of a metal belt, i.e., a belt made of metal, e.g., steel. The metal belt support may be a continuous conveyor belt. As mentioned above, the metal belt support has a casting surface on which the MFC suspension is casted. Preferably, the metal belt support has a smooth casting surface, i.e., a smooth surface on which the MFC suspension is casted. In some embodiments, the metal belt support has a casting surface with a smoothness resulting in a Bendtsen roughness of 200 ml/min or less, preferably 150 ml/min or less, more preferably 100 ml/min or less, as measured by ISO 8791-2:2013 and/or a Parker Print-Surf (PPS) smoothness of 10 μm or less, preferably 0.1-5 μm, most preferably 0.3-5 μm, as determined according to ISO 8791-4 with a clamping pressure of 1.0 MPa, of the side of the produced MFC layer being in contact with the casting surface of the metal belt support. Alternatively, the casting surface of the metal belt support is textured. Also, the metal belt support has a reverse surface opposite the casting surface.

Preferably, the MFC suspension is in direct contact with the casting surface of the metal belt support after casting. However, in some embodiments a coating for controlling adhesion and release properties may be applied on the casting surface of the metal belt support, before the MFC suspension is casted on the casting surface. Examples of agents of such a coating are poly(aminoamide)-epihalohydrin polymer (PAE) resins, polyvinyl alcohol resins (PVOH), polyvinyl alcohol copolymers, starches, ethylene glycol, vegetable oils, fatty acids and sugar alcohols.

The formed wet MFC layer can be a web consisting of one layer or multiple sublayers, or a single ply or multiply web, made with one or several casting units. Thus, in some embodiments, the wet MFC layer comprises a single web layer or two or more web layers formed on top of each other.

As mentioned above, the method of the first aspect comprises a step of providing a paper substrate web. The paper substrate of the paper substrate web has a Gurley Hill air permeability value of less than 10000 s/100 ml, preferably less than 5000 s/100 ml, more preferably less than 1000 s/100 ml or less than 200 s/100 ml as measured according to standard ISO 5636-5:2013. A Gurley Hill air permeability value of less than 10000 s/100 ml of the paper substrate promotes transfer of water from the wet MFC layer through the paper substrate during water removal according to the first aspect of the method.

Paper generally refers to a material manufactured in thin sheets from the pulp of wood or other fibrous substances comprising cellulose fibers, used for writing, drawing, or printing on, or as packaging material. The paper substrate can be made from pulp, including pulp from virgin fiber, e.g., mechanical, semi-chemical, chemical and/or thermomechanical pulps. It can also be made from broke or recycled paper. The paper used as a substrate in accordance with the present disclosure is prepared using methods known in the art.

The paper substrate used in the method of the first aspect has preferably a basis weight in the range of 10-200 g/m², more preferably in the range of 10-100 g/m².

The paper substrate used in the method of the first aspect may comprise one layer or multiple layers. In one embodiment, the paper substrate comprises at least 10% recycled material, such as at least 20% or at least 40% or at least 50% or at least 60% or at least 70% recycled material, which can be either pre- or post-consumer grade.

The paper substrate may be subjected to surface sizing or a surface treatment on at least one side of the paper substrate. Such surface sizing or surface treatment is then part of the paper substrate in the context of the present disclosure.

As mentioned above, the method of the first aspect comprises a step of joining the paper substrate web with the wet MFC layer positioned on the casting surface of the metal belt support to form a laminate structure positioned on the casting surface of the metal belt support. Thus, the joining step implies that the paper substrate web is joined with the wet MFC layer which already is positioned on the casting surface of the metal belt support, i.e., the paper substrate web is joined with the opposite side of the wet MFC layer compared to the metal belt support. By the joining step, a laminate structure is formed which comprises the wet MFC layer and the paper substrate web. The wet MFC layer is positioned between the metal belt support and the paper substrate web after the joining.

According to the method of the first aspect, the wet MFC layer has a dry content of 1-40 weight-%, preferably 2-25 weight-%, more preferably 3-15 weight-%, most preferably 3.5-8 weight-% when the paper substrate web is joined with the wet MFC layer. The paper substrate web has a dry content of at least 70 weight-%, preferably at least 80 weight-%, most preferably at least 85 weight-% when the paper substrate web is joined with the wet MFC layer. The specified dry content ranges facilitate infiltration into the paper substrate, while still enabling a quick removal of water from the wet MFC layer through the paper substrate. The dry content of the wet MFC layer and the paper substrate web, respectively, may be determined according to the standard ISO 638 or by a spectroscopic method. Alternatively, the dry content may be determined by using devices or instruments used for determining the moisture content and calculating the dry content from the moisture content measurement. The dry content and the moisture content may be measured under ambient conditions.

As mentioned above, the method of the first aspect comprises a step of subjecting the laminate structure positioned on the casting surface of the metal belt support to water removal to form a laminate comprising a paper substrate and an MFC layer. The formed laminate has an average dry content of at least 80 weight-%, such as 80-99.9 weight-%, preferably 85-99 weight-% or 86-98 weight-% or 90-99.5 weight-% or 92-99 weight-%. Thus, water is removed during the step of water removal such that the laminate has the specified average dry content, i.e., water is removed until the specified average dry content is obtained, whereby the laminate is formed. The average dry content may be measured under ambient conditions. For example, the average dry content may be measured by spectroscopic methods (NIR, IR), optical methods or microwave-based methods or radiography, er electrical or dielectric methods or by using e.g., Teraherz technology. Alternatively, the average dry content of the laminate may be measured according to standard ISO 638. In another alternative, the average moisture content may be measured in order to determine the average dry content. The moisture content may be measured under ambient conditions. The laminate structure is positioned on the casting surface of the metal belt support during the water removal. The water removal comprises at least one drying step, i.e., the water removal may comprise one, two, three or more drying steps. The laminate structure is dried during each of the at least one drying step by non-contact drying by at least one non-contact drying device arranged on the side of the laminate structure opposite the metal belt support (i.e., arranged at a distance from the laminate structure on the side of the laminate structure opposite the metal belt support). Also, the metal belt support is heated during the at least one drying step.

Thus, the laminate structure is dried during each drying step by a combination of non-contact drying by at least one non-contact drying device and heating of the metal belt support. The heating of the laminate structure, during the non-contact drying of the laminate structure, by heating the metal belt support implies that contact drying of the laminate structure also is provided at the side of the wet MFC layer being in contact with the metal belt support.

Thus, when the laminate structure is subjected to one of the at least one drying step, it is positioned on the casting surface of the metal belt support, which is heated, while being subjected to non-contact drying by the at least one non-contact drying device. Accordingly, the laminate structure is dried by simultaneous non-contact drying and contact drying.

Thus, after the joining step the laminate structure is dried by non-contact drying with one or more non-contact drying devices in one or more drying steps, wherein the laminate structure is positioned on the casting surface of the metal belt support during the non-contact drying and wherein the one or more non-contact drying devices are positioned on one side of the laminate structure (i.e., not in contact with the laminate structure) and the metal belt support is positioned on the other side of the laminate structure (i.e., in contact with the MFC layer) and heated during the non-contact drying.

In some embodiments, the metal belt support is heated to a temperature above 30° C., preferably between 30-150° C., more preferably between 45-150° C., even more preferred between 60-100° C., during the drying step(s). For example, the metal belt support may be heated by steam heating of the metal belt, by hot air, by means of electrical heating, inductively, or with radiation heat source. Depending on the process configuration, the metal belt support can also be heated, e.g., to a temperature within the above given temperature ranges, during other steps or parts of steps of the method of the first aspect, e.g., during the step of forming a wet MFC layer and/or during the step of joining the paper substrate web with the wet MFC layer and/or during optional dewatering step(s). In some embodiments, the metal belt support is heated, e.g., to a temperature within the above given temperature ranges, in all steps of the method of the first aspect or at least between formation of the wet MFC layer on the metal belt support and the separation of the laminate from the metal belt support.

Since the wet MFC layer is positioned on the casting surface of the metal belt support and since the paper substrate is positioned on the side of the MFC layer opposite the metal belt support according to the method of the first aspect, water from the wet MFC layer needs to penetrate/migrate through the paper substrate in order to dry the wet MFC layer. It has surprisingly been found that it is possible to dry the wet MFC layer, which contains a relatively high amount of water, of the laminate structure positioned on the casting surface of the metal belt support according to the first aspect of the method by water penetrating from the MFC layer through the paper substrate, by using one or more non-contact drying devices positioned on the side of the laminate structure opposite the metal belt support and heating of the metal belt support, and by the paper substrate having a Gurley Hill air permeability value of less than 10000 s/100 ml.

Thus, during the at least one drying step of the method of the first aspect, water penetrates/migrates from the wet MFC layer through the paper substrate by use of the one or more non-contact drying devices and heating of the metal belt support.

Also, the MFC layer has been found to adhere strongly to the surface of the paper substrate by using the method of the first aspect. Without being bound to any theory, it is believed that the strong adhesion is due to mechanical interlocking of the fibers and fibrils and/or intermolecular interactions. Thus, the need of using adhesive between the paper substrate and the MFC layer is reduced or eliminated.

Thus, the paper substrate may be positioned directly on, i.e., in direct contact with, the wet MFC layer. Accordingly, in some embodiments the provided laminate comprises no adhesive or tie layer between the paper substrate and the MFC layer. Alternatively, an adhesive, such as an adhesion chemical/agent or adhesion promoting chemical/agent, or adhesive coating further promoting the adhesion may be provided between the MFC layer and the paper substrate, i.e., provided on the wet MFC layer or on the paper substrate before the joining. For example, the adhesion can be promoted with anionic, cationic or nonionic polymers. The adhesive may be any adhesive commonly used in the preparation of laminates for use as packaging products. The adhesives are typically provided in liquid form, for example as a dispersion, emulsion or solution. One or more layers of adhesive can be provided between the paper substrate and the MFC layer. However, only small amounts of adhesive, such as less than 4 g/m² or less than 2 g/m² or 0.1-1.5 g/m², may be utilized between the MFC layer and the paper substrate in order to not hinder the transport of water and steam through the paper substrate. Alternatively, an adhesive that passes water and steam needs to be utilized, e.g., selected from natural gums or polysaccharides or derivatives thereof, such as starch, CMC, methyl cellulose, a polyelectrolyte solution or polyvinyl alcohol or derivatives or analogues thereof.

Each of the one or more non-contact drying devices may be any known suitable drying device based on a non-contact drying technique. For example, each of the one or more non-contact drying devices may be selected from the group of hot gas impingement drying devices, such as hot air impingement drying devices or hot steam impingement drying devices, air dryers, microwave drying devices, ultraviolet (UV) drying devices, electron beam drying devices, infrared (IR) drying devices and near infrared (NIR) drying devices. If more the one non-contact drying device are utilized, the non-contact drying devices may be of the same or different types.

As mentioned above, the method of the first aspect comprises a step of separating the laminate from the metal belt support, i.e., separating (e.g., peeling off) the dried laminate structure from the metal belt support after the drying. The laminate may have an average dry content (i.e., in the thickness direction) of at least 80 weight-%, such as 80-99.9 weight-%, preferably 85-99 weight-% or 86-98 weight-% or 90-99.5 weight-% or 92-99 weight-%, at the separation.

In some embodiments, the laminate is further dried after separation from the metal belt support. The further drying may be performed by non-contact drying, e.g., utilizing one or more non-contact drying devices, which may be any known suitable drying device based on a non-contact drying technique such as selected from the group of non-contact drying devices provided in connection with the at least one drying step of the first aspect. Alternatively, or additionally, cylinder drying based on contact drying with heated cylinders may be utilized. One advantage with cylinder drying may be improved moisture uniformity in the thickness direction of the laminate by contacting the paper side of the laminate with heated cylinder(s).

The joining of the method of the first aspect may be performed by positioning the paper substrate web on, such as on top of, the wet MFC layer positioned on the casting surface of the metal belt support, e.g., by unwinding the paper substrate web from a roll and conveying and guiding the paper substrate web to be positioned on, such as on top of, the wet MFC layer positioned on the casting surface of the metal belt support.

Preferably, the metal belt support with the casted wet MFC layer and the paper substrate web are conveyed before the joining step with the same or essentially the same speed so as to avoid or minimize damages to the wet MFC layer at the joining.

In some embodiments, the metal belt support provided with the MFC layer and the paper substrate web, i.e., the laminate structure, is downstream of drying by at least one non-contact drying device guided at least partly around a guide roll so as to provide tension in the paper substrate and, thus, pressure of the paper substrate web onto the wet MFC layer at the joining.

In some embodiments, the metal belt support provided with the MFC layer and the paper substrate web, i.e., the laminate structure, is downstream of joining of the wet MFC layer and the paper substrate web, but upstream of the drying by at least one non-contact drying device, guided at least partly around a guide roll so as to provide tension in the paper substrate and, thus, pressure of the paper substrate web onto the wet MFC layer at the joining.

In some embodiments, the metal belt support provided with the wet MFC layer and the paper substrate web, i.e., the laminate structure, is conveyed through one or more press devices, e.g., one or more press nips formed by a pressing element and a counter element, in order to further increase or promote the bonding between the MFC layer and the paper substrate. The one or more press devices may be provided at any suitable position, e.g., downstream of at least one non-contact drying device. In some embodiments, the metal belt support provided with the laminate structure is conveyed through at least one press nip selected from the group of a press nip positioned upstream the at least one non-contact drying device, a press nip positioned downstream the at least one non-contact drying device and a press nip positioned between two separate non-contact drying devices. In some embodiments, the linear load of the at least one press device is 1-150 kN/m, preferably 5-100 kN/m. In some embodiments, the absolute pressure of the at least one press device is 1-25000 kPa, preferably 3-17000 kPa.

In some embodiments, the metal belt support provided with the laminate structure is not conveyed through any press device or press nip. Thus, in these embodiments the method according to the first aspect is performed without the use of any press device or press nip, i.e., free of any press device or press nip.

In some embodiments, the method of the first aspect further comprises a further step of pre-drying the wet MFC layer positioned on the casting surface of the metal belt support before the step of joining the paper substrate web with the wet MFC layer. The pre-drying may be performed so as to increase the dry content by 0-20% units, preferably 1-20% units or 1-10% units. In some embodiments, the step of pre-drying the wet MFC layer comprises drying the wet MFC layer by heating so that the dry content of the wet MFC layer is increased by evaporation before the step of joining the wet MFC layer with the paper substrate web. The heating may also reduce the viscosity of the liquid phase of the MFC suspension. Thus, in embodiments comprising a step of pre-drying, the wet MFC layer is pre-dried after formation of the wet MFC layer on the casting surface of the metal belt support but before the joining step. For example, the pre-drying step may be necessary to perform when the dry content of the wet MFC layer is 1-20 weight-%, or 1-15 weight-% or 1-10 weight-%. For example, the pre-drying may be performed by evaporation, impingement drying with hot gas/air, IR, NIR, microwaves, thermal heating, any other method well known in the art or combinations thereof. For example, the heating may be performed by heating the metal belt support, i.e., a heated metal belt support may be utilized in the pre-drying step.

In some embodiments, the method of the first aspect further comprises a step of dewatering the wet MFC layer positioned on the casting surface of the metal belt support before the step of joining the paper substrate web with the wet MFC layer, wherein the dewatering of the wet MFC layer is performed by applying a press fabric in direct contact with the wet MFC layer and conducting the wet MFC layer, arranged between the press fabric and the metal belt support, through a pressing equipment. These embodiments may also include a step of pre-drying, as described above, before the step of dewatering. The dewatering may be performed to remove 10-70% such as 20-65% or 30-60% of the water in the wet MFC layer.

In some embodiments, the water removal of the method of the first aspect further comprises a step of dewatering the laminate structure positioned on the casting surface of the metal belt support after the step of joining but before the at least one drying step, wherein the dewatering of the laminate structure is performed by applying a press fabric in direct contact with the paper substrate web of the laminate structure and conducting the laminate structure, arranged between the press fabric and the metal belt support, through a pressing equipment. Alternatively, the dewatering of the laminate structure in these embodiments may be performed by applying a porous wire or a membrane in direct contact with the paper substrate web and conducting the laminate structure, arranged between the porous wire or membrane and the metal belt support, through a vacuum dewatering equipment, in which the porous wire or membrane is covering one or several vacuum cavities that causes water to be removed from the laminate structure. The dewatering may be performed to remove 10-70% such as 20-65% or 30-60% of the water in the wet MFC layer.

In some embodiments, the water removal of the method of the first aspect comprises at least two drying steps and further comprises a step of dewatering the laminate structure positioned on the casting surface of the metal belt support between two drying steps, wherein the dewatering of the laminate structure is performed by applying a press fabric in direct contact with the paper substrate web of the laminate structure and conducting the laminate structure, arranged between the press fabric and the metal belt support, through a pressing equipment. Alternatively, the dewatering of the laminate structure in these embodiments may be performed by applying a porous wire or a membrane in direct contact with the paper substrate web and conducting the laminate structure, arranged between the porous wire or membrane and the metal belt support, through a vacuum dewatering equipment, in which the porous wire or membrane is covering one or several vacuum cavities that causes water to be removed from the laminate structure.

With press fabric is meant a fabric that is permeable and allows water to be removed from the web either by absorbing the water or by allowing the water to be removed through the fabric. The press fabric may be a press felt (dewatering felt). Press fabrics and press felts are today often used for dewatering of paper and paperboard webs. Any known suitable press fabric or press felt may be utilized. More than one press fabric, i.e., two or more press fabrics subsequent to each other in the machine direction, may be utilized.

The fact that the MFC layer is kept positioned on the casting surface of the metal belt support during the at least one drying step and the optional dewatering step(s), implies that restrained drying and restrained dewatering of the MFC layer is enabled and also a high smoothness and dense surface. The restrained drying and optional restrained dewatering may imply no shrinkage or less than 10%, less than 5% or less than 3% shrinkage. Also, the restrained drying and optional restrained dewatering and contact with metal belt support will enable a texture image to be transferred from the metal belt support to the MFC layer. Furthermore, the method of the present disclosure enables formation of one side that is dense and compact, i.e., the MFC layer side, whereas the paper substrate provides strength and good convertability.

In some embodiments, the paper substrate web is pre-moistened before the joining step to pre-wet the paper substrate. Without being bound to any theory, it is believed that the pre-moistening of the paper substrate promotes the capillary water transport from the wet MFC layer through the paper substrate when they are joined. Also, the pre-wet paper substrate is dried into new dimensions under restrained conditions during the step(s) of drying the laminate structure.

In some embodiments, the paper substrate web is pre-heated, optionally in combination with pre-moistening as described above, before the joining step in order to lower the water viscosity when entering the joining step, which will improve water transport through the paper substrate.

In some embodiments, the obtained laminate has an oxygen transmission rate (OTR), measured according to the standard ASTM F1927-20 at 50% relative humidity and 23° C., of less than 15 cc/m²/24 h, preferably less than 10 cc/m²/24 h, and more preferably less than 5 cc/m²/24 h.

In some embodiments, the obtained laminate has a water vapor transmission rate (WVTR), measured according to the standard ASTM F1249-20 at 50% relative humidity and 23° C., of less than 100 g/m²/24 h, preferably less than 75 g/m²/24 h, and more preferably less than 50 g/m²/24 h. This makes the laminate according to the present disclosure an interesting and viable alternative to conventional materials using aluminum foil layers.

In some embodiments, an outermost side of the MFC layer of the obtained laminate, i.e., the side of the MFC layer that has been in contact with the metal belt support, has a Bendtsen roughness of 200 ml/min or less, preferably 150 ml/min or less or 100 ml/min or less, as measured by ISO 8791-2:2013 and/or a Parker Print-Surf (PPS) smoothness of 10 μm or less, preferably 0.1-5 μm, most preferably 0.3-5 μm, as determined according to ISO 8791-4 with a clamping pressure of 1.0 MPa. The high smoothness implies that the laminate is suitable for vacuum deposition coating.

Vacuum coating, or vacuum deposition coating, refers to a family of processes used to deposit layers of metals, metal oxides and other inorganic and organic compositions, typically atom-by-atom or molecule-by-molecule, on a solid surface. Multiple layers of the same or different materials can be combined. The process can be further specified based on the vapor source; physical vapor deposition (PVD) uses a liquid or solid source and chemical vapor deposition (CVD) uses a chemical vapor. Atomic layer deposition (ALD) may also be utilized. For example, the laminate according to the present disclosure may be provided with a vacuum coating layer comprising a metal or metal oxide selected from the group consisting of aluminum, magnesium, silicon, copper, aluminum oxides, magnesium oxides, silicon oxides, and combinations thereof, preferably an aluminum oxide.

In some embodiments, the obtained laminate has a Scott Bond value of >50 J/m², preferably >80 J/m² as measured with TAPPI 569.

In some embodiments, the obtained laminate has a Z-strength value of >200 kPa, preferably >250 kPa as measured with TAPPI 541.

As mentioned above, the dry grammage (basis weight) of the MFC layer of the laminate is 8-70 g/m², preferably 10-50 g/m², most preferably 15-40 g/m², as measured according to ISO 536:2019.

In some embodiments, the MFC of the MFC suspension has a water retention value (WRV)>120%, such as 150-350% as measured according to the standard ISO 23714.

In some embodiments, the obtained laminate has a KIT value of at least 10, as measured according to standard ISO 16532-2, when measured from the MFC layer side.

There is a demand for improved solutions to replace aluminum foils and barrier plastic layers, such as polyolefin films, as barrier layers and substrates in packaging materials with alternatives that facilitate re-pulping and recycling of the used packaging materials. The laminate according to the present disclosure can advantageously be manufactured almost entirely from biobased materials, and preferably from cellulose-based materials, thereby facilitating re-pulping and recycling of used packaging materials comprising the laminate according to the present disclosure.

The laminate according to the present disclosure can provide an alternative to conventional materials using barrier plastic layers, such as polyolefin films, and/or aluminum foil layers, which can more readily be repulped and recycled. In some embodiments, the laminate has a reject rate according to PTS RH 021/97 of less than 30%, preferably less than 20%, more preferably less than 10%, most preferably less than 5%. The laminate according to the present disclosure may provide at least a reduction of the use of barrier plastic layers and/or aluminum foil layers as used in conventional materials.

However, the laminate of the present disclosure may further be provided with an outermost polymer layer on one side or on both sides. The outermost polymer layers preferably provide liquid barrier properties and mechanical protection, such as print protection, for the laminate surface(s). The outermost polymer layer is preferably also heat-sealable.

In some embodiments, the laminate of the present disclosure is provided with a first outermost polymer layer, preferably a polyethylene layer, arranged on the paper substrate.

In some embodiments, the laminate of the present disclosure further is provided with a second outermost polymer layer, preferably a polyethylene layer, arranged on the MFC layer.

The outermost polymer layers may of course interfere with repulpability but may still be required or desired in some applications. The additional polymer layers may for example be applied by extrusion coating, film lamination or dispersion coating after the laminate is formed.

The outermost polymer layers may comprise any of the thermoplastic polymers commonly used in protective and/or heat-sealable layers in paper based packaging laminates in general or polymers used in liquid or food packaging board in particular.

Examples include polyethylene (PE), polyethylene terephthalate (PET), polyethylene furanoate (PEF), polypropylene (PP), polyhydroxyalkanoates (PHA), polylactic acid (PLA), polyglycolic acid (PGA), starch and cellulose. Polyolefins, such as polyethylenes, especially low density polyethylene (LDPE) and high density polyethylene (HDPE), are the most common and versatile polymers used in liquid or food packaging board. The polymers used are preferably manufactured from renewable materials.

Thermoplastic polymers are useful since they can be conveniently processed by extrusion coating techniques to form very thin and homogenous films with good liquid barrier properties. In some embodiments, the outermost polymer layers comprise polypropylene or polyethylene. In preferred embodiments, the outermost polymer layers comprise polyethylene, more preferably LDPE or HDPE.

In some embodiments, the outermost polymer layers are formed by extrusion coating of the polymer onto the laminate. Extrusion coating is a process by which a molten plastic material is applied to a substrate to form a very thin, smooth, uniform layer. The coating can be formed by the extruded plastic itself, or the molten plastic can be used as an adhesive to laminate a solid plastic film onto the substrate.

The basis weight of each of the outermost polymer layers is preferably less than 50 g/m². In order to achieve a continuous and substantially defect free film, a basis weight of the outermost polymer layer of at least 6 g/m², preferably at least 8 g/m² or at least 12 g/m² is typically required if provided by extrusion coating. In some embodiments, the basis weight of the outermost polymer layer is in the range of 6-50 g/m², preferably in the range of 8-50 g/m² or 10-25 g/m² or 10-20 g/m² or 12-20 g/m², wherein the outermost polymer layer is provided by extrusion coating. In some embodiments, the basis weight of the outermost polymer layer is in the range of 2-10 g/m², wherein the outermost polymer layer is provided by foamed film.

According to a second aspect of the present disclosure there is provided a laminate comprising a paper substrate and an MFC layer, which laminate is obtainable by the method of the first aspect.

According to a third aspect of the present disclosure, there is provided a laminate comprising a paper substrate and an MFC layer, wherein the MFC layer comprises between 50 weight-% to 100 weight-% MFC based on total dry weight and has a grammage of 8-70 g/m², such as 9-70 g/m² or 10-70 g/m² and has an average dry content of at least 80 weight-%. The laminate may have an oxygen transmission rate (OTR), measured according to the standard ASTM F1927-20 at 50% relative humidity and 23° C., of less than 15 cc/m²/24 h, preferably less than 10 cc/m²/24 h, more preferably less than 5 cc/m²/24 h, and a water vapor transmission rate (WVTR), measured according to the standard ASTM F1249-20 at 50% relative humidity and 23° C., of less than 100 g/m²/24 h, preferably less than 75 g/m²24 h, more preferably less than 50 g/m²/24 h. In some embodiments, the laminate comprises no lamination adhesive or tie layer between the paper substrate and the MFC layer, i.e., the laminate is free of lamination adhesive and tie layer between the paper substrate and the MFC layer.

Preferably, the paper substrate has a basis weight in the range of 10-200 g/m², more preferably in the range of 10-100 g/m². The paper substrate may have a filler content between 0-20 weight-%, such as 1-20 weight-% or 3-15 weight-%.

In some embodiments, an outermost side of the MFC layer of the laminate of the third aspect has a Bendtsen roughness of 200 ml/min or less, preferably 150 ml/min or less, more preferably 100 ml/min or less, as measured by ISO 8791-2:2013 and/or a PPS smoothness of 10 μm or less, preferably 0.1-5 μm, most preferably 0.3-5 μm, as determined according to ISO 8791-4 with a clamping pressure of 1.0 MPa.

The laminate, the MFC layer and the paper substrate according to the third aspect may be further defined as set out above with reference to the method of the first aspect.

The laminate of the second aspect and the third aspect can be used as such, or it can be combined with one or more further layers such as one or more further paper or paperboard layers and/or other layers. When the laminate is combined with one or more further layers, such as one or more paper or paperboard layers, into a laminated material, the laminated material may optionally be provided with an outermost polymer layer (corresponding to the outermost polymer layer described above) on one side or on both sides. Other examples of further layers that may be combined with the laminate obtainable by the method of the first aspect are further polymer layers such that there are multiple polymer layers of same or different polymers on each side, a protective varnish layer, a décor layer on top of the laminate, and a sealing layer that can be activated (molten) with heat.

For example, the laminate can be used as a packaging material or in a packaging material, such as a food or liquid packaging material. For example, the laminate can be part of a flexible packaging material, such as a free-standing pouch or bag. Thus, the laminate may be used as bag material in boxes when packaging dry food such as cereals. Furthermore, the laminate may be used as a wrapping substrate, such as a flow wrap material, as a laminate material in paper, paperboard or plastics and/or as a substrate for disposable electronics. The laminate may also be included in for example a closure, a lid or a label. The laminate can be incorporated into any type of package, such as a box, bag, wrap, wrapping film, cup, container, tray, bottle etc. The present disclosure also relates to a packaging product comprising the laminate obtainable by the method of the first aspect or the laminate according to the third aspect.

According to a fourth aspect of the present disclosure, there is provided a method for manufacturing a packaging material, said method comprising i) providing a paper or paperboard base layer and ii) laminating a laminate according to the second aspect or the third aspect to the paper or paperboard base layer using at least one tie layer to obtain the packaging material.

As mentioned above, paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements. Paperboard may be a single ply material, or a multiply material comprised of two or more plies. A common type of multiply paperboard is comprised of a lower density mid-ply (also sometimes referred to as “bulk ply”) sandwiched between two higher density outer plies. The lower density mid-ply may typically have a density below 750 kg/m³, preferably below 700, below 650, below 600, below 550, below 500, below 450, below 400 or below 350 kg/m³. The higher density outer plies typically have a density at least 100 kg/m³ higher than the mid-ply, preferably at least 200 kg/m³ higher than the mid-ply.

The paper or paperboard base layer can be made from pulp, including pulp from virgin fiber, e.g., mechanical, chemical and/or thermomechanical pulps. It can also be made from broke or recycled paper. In addition to the paper or paperboard base layer and the laminate according to the second aspect or the third aspect, the packaging material may comprise additional layers or coatings designed to improve the performance and/or appearance of the packaging material.

The packaging material typically has a first outermost surface intended to serve as the outside surface, or print side, and a second outermost surface intended to serve as the inside surface of a packaging container. The side of the paper or paperboard base layer comprising the inventive laminate is preferably intended to serve as the inside surface of a packaging container.

In some embodiments, the paper or paperboard base layer has a grammage of at least 100 g/m². In some embodiments, the paper or paperboard base layer has a grammage of at least 150 g/m², 200 g/m², 250 g/m², 300 g/m², 350 g/m², or 400 g/m². The grammage of the paper or paperboard base layer is preferably below 1000 g/m², 800 g/m², or 600 g/m². Unless otherwise stated, the grammage is determined according to the standard ISO 536.

In some embodiments, the paper or paperboard base layer has a density below 700 kg/m³, preferably below 600 kg/m³. Unless otherwise stated, the density is determined according to the standard ISO 534.

The paper or paperboard base layer may be a single ply paperboard or a multiply paperboard. In some embodiments, the paper or paperboard base layer is a multiply paperboard. In some embodiments the paper or paperboard base layer is a multiply paperboard comprised of two or more plies. In some embodiments the paper or paperboard base layer is a multiply paperboard comprised of three or more plies. In some embodiments the paper or paperboard base layer is a multiply paperboard comprised of a lower density mid-ply sandwiched between two higher density outer plies.

In some embodiments, the paper or paperboard base layer is a foam formed paperboard. In some embodiments wherein the paper or paperboard base layer is a multiply paperboard, at least one of the plies, preferably a mid-ply, is foam formed.

The tie layer may comprise any suitable adhesive commonly used in paper or paperboard based packaging laminates in general or adhesives used in liquid or food packaging board in particular. Many different types of adhesives and adhesive coating methods may be used with the invention.

The tie layer may comprise one or more adhesive polymers. The tie layer may be comprised entirely of the one or more adhesive polymers, or it may also further comprise other additives for improving the properties of the adhesive layer. In some embodiments, the tie layer comprises at least 50 weight-% of an adhesive polymer or mixture of adhesive polymers based on dry weight. In some embodiments, the tie layer comprises or consists of one or more adhesive polymers selected from the group consisting of polyolefins, polyesters, polyurethanes, and acrylic copolymers. In some embodiments, the tie layer comprises or consists of one or more of polypropylene and polyethylene, such as low density polyethylene (LDPE) or high density polyethylene (HDPE). In some embodiments, the adhesive layer comprises or consists of a component selected from adhesive thermoplastic polymers, such as modified polyolefins, which are mostly based on LDPE or LLDPE co-polymers or, graft co-polymers with functional-group containing monomer units, such as carboxylic or glycidyl functional groups, e.g., (meth)acrylic acid monomers or maleic anhydride (MAH) monomers, (i.e., ethylene acrylic acid copolymer (EAA) or ethylene methacrylic acid copolymer (EMAA)), ethylene-glycidyl (meth)acrylate copolymer (EG(M)A) or MAH-grafted polyethylene (MAHg-PE). Another example of such modified polymers or adhesive polymers are so called ionomers or ionomer polymers. Preferably, the modified polyolefin is an ethylene acrylic acid copolymer (EAA) or an ethylene methacrylic acid copolymer (EMAA).

In some embodiments, the tie layer comprises at least 50 weight-% of a water-soluble polymer or mixture of water-soluble polymers based on dry weight. The water-soluble polymer of the tie layer is soluble in cold water or soluble in hot water, e.g., at a temperature below 100° C. or even above 100° C., for a given period of time. In some embodiments, the water-soluble polymer is selected from the group consisting of a polyvinyl alcohol (PVOH) or derivatives or analogues thereof, a carboxymethyl cellulose (CMC), a starch, an alginate, and a hemicellulose, preferably a PVOH.

The tie layer may be applied by any suitable method known in the art. The total coat weight of the one or more tie layers may generally be in the range of 1-20 g/m². In some embodiments, the total coat weight of the one or more tie layers is in the range of 2-15 g/m², more preferably in the range of 3-12 g/m².

According to a fifth aspect of the present disclosure, there is provided a packaging material obtained by a method according to the fourth aspect.

The packaging material may further be provided with an outermost polymer layer on one side or on both sides. The outermost polymer layers preferably provide liquid barrier properties and mechanical protection for the packaging material surface. The outermost polymer layer is preferably also heat-sealable. The polymer layer(s) may be further defined as described above with reference to the first aspect.

In some embodiments, the packaging material comprises a first outermost polymer layer, preferably a polyethylene layer, arranged on the paper or paperboard base layer.

In some embodiments, the packaging material further comprises a second outermost polymer layer, preferably a polyethylene layer, arranged on the laminate according to the second or third aspect.

According to a sixth aspect of the present disclosure, there is provided use of the laminate obtainable by the method of the first aspect or the laminate according to the third aspect as a packaging material or in a packaging material.

Some examples of possible structures of the laminate according to the present disclosure are shown below:
A/B
C/A/B/C
C/A/B
A/B/C
   wherein A is paper substrate, B is MFC layer and C is sealing and/or liquid barrier such as polyolefin.

Some examples of possible structures of the packaging material according to the present disclosure are shown below:
C/E/D/A/B/C
C/E/D/B/A/C
   wherein A is paper substrate, B is MFC layer, C is sealing and/or liquid barrier such as polyolefin, D is tie layer, and E is paper or paperboard base layer.

### BRIEF DESCRIPTION OF THE FIGURES

FIG. 1 shows a schematic overview of one embodiment of the process according to the present disclosure.

FIG. 2 shows a schematic overview of another embodiment of the process according to the present disclosure.

FIG. 3 shows a schematic overview of a further embodiment of the process according to the present disclosure.

### DETAILED DESCRIPTION OF THE FIGURES

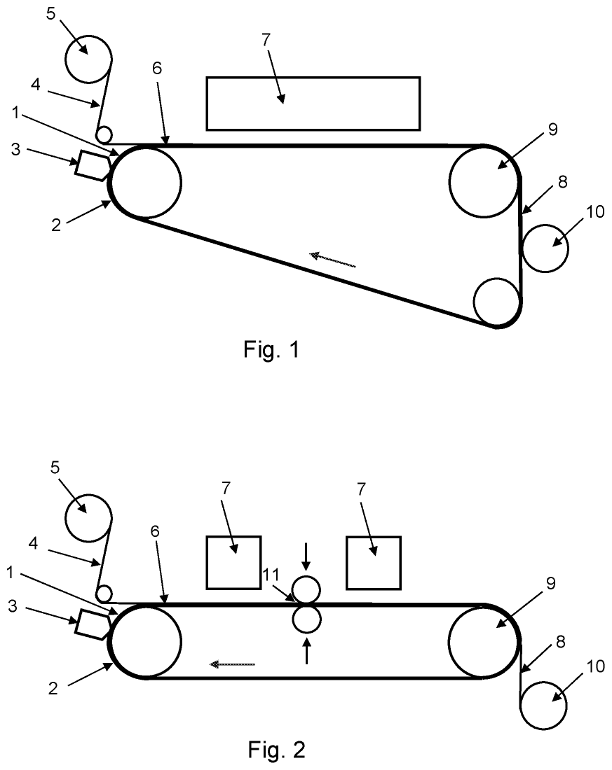

FIG. 1 shows a schematic overview of one embodiment of the method according to the first aspect of the present disclosure. A wet MFC layer 1 is formed on a casting surface of a continuous metal belt support 2 by casting of an MFC suspension by a casting unit 3. A paper substrate web 4 is unwound from a roll 5 and guided and conveyed to be joined with the wet MFC layer 1, i.e., to be positioned on top of the wet MFC layer positioned on the casting surface of the metal belt support 2, whereby a laminate structure 6 is formed. The laminate structure 6 formed by the joining and positioned on the casting surface of the metal belt support 2 is thereafter subjected to water removal in a drying step. In the drying step the laminate structure 6 is dried to form a laminate 8, wherein the drying is performed by non-contact drying by a non-contact drying device 7 in combination with heating of the metal belt support 2. The non-contact drying device 7 is arranged on the side of the laminate structure 6 opposite the metal belt support 2. The metal belt support 2 is downstream of the non-contact drying guided partly around a guide roll 9, which provides tension in the paper substrate web 4 and pressure of the paper substrate web 4 on the wet MFC layer 1 at the joining. After drying, the laminate 8 is separated from the metal belt support 2 and wound onto a roll 10.

FIG. 2 shows a schematic overview of another embodiment of the process according to the present disclosure. The embodiment of FIG. 2 corresponds mainly to the embodiment of FIG. 1. However, in the embodiment of FIG. 2 the laminate structure 6 is dried by two non-contact drying devices 7 in combination with heating of the metal belt support 2 and the laminate structure 6 is conveyed through a press nip 11 between the drying by the two non-contact drying devices 7.

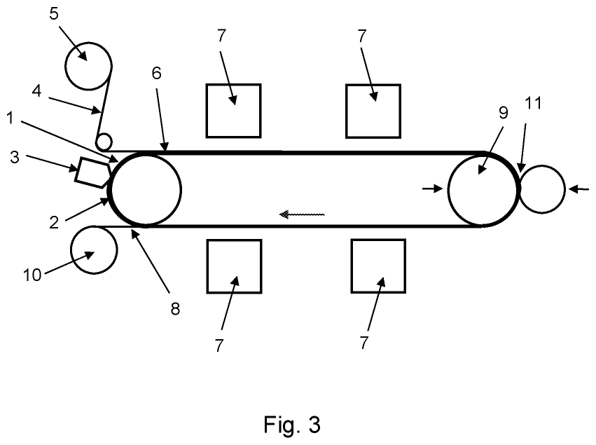

FIG. 3 shows a schematic overview of another embodiment of the process according to the present disclosure. The embodiment of FIG. 3 corresponds mainly to the embodiment of FIG. 2. However, in the embodiment of FIG. 3 the laminate structure 6 is dried by four non-contact drying devices 7 in combination with heating of the metal belt support 2 and the laminate structure 6 is conveyed through a press nip 11 after drying by two non-contact drying devices 7.

Generally, while the products, materials, layers and processes are described in terms of “comprising” various components or steps, the products, materials, layers and processes can also “consist essentially of” or “consist of” the various components and steps.

In view of the above detailed description of the present invention, other modifications and variations will become apparent to those skilled in the art. However, it should be apparent that such other modifications and variations may be effected without departing from the spirit and scope of the invention.

### EXAMPLES

### Methods

In the below Examples, the following measurement methods were used:
Schopper Riegler values (SR°) were measured according to standard ISO 5267-1
Grammage was determined according to ISO 536:2019
Thickness (single sheet) was determined according to ISO 534.
PPS 1.0 MPa smoothness was determined according to ISO 8791-4
Water vapor transmission rate (WVTR) was measured according to the standard ASTM F1249-20 at 50% relative humidity and 23° C.
Oxygen transmission rate (OTR) was measured according to the standard ASTM F1927-20 at 50% relative humidity and 23° C.
Air resistance (Gurley Hill, G-H) values were measured according to ISO 5636-5. Max value with the device was 42 300 s/100 ml
Oil grease resistance (OGR) was determined according to modified ASTM F119-82, in which the fabric in which grease is applied is ordinary cotton instead of cotton flannel rifle cleaning fabric.
Cobb60 water absorption values were measured according to SCAN P12:64 for 60 seconds
Density was determined according to ISO 534:2011
Bendtsen Roughness was determined according to ISO 8791-2:2013.
Scott-Bond was determined according to TAPPI 569
Z-strength was determined according to TAPPI 541

### Comparative Example 1 (Laminate without Adhesive)

A barrier substrate comprising highly refined cellulose pulp prepared on dewatering fabric (wire) was formed as a thin sheet and then dried. The sheet had a grammage of 31.4 gsm and thickness of 47 μm, Gurley Hill value of 14 100 s/100 ml, confirming that it had no barrier properties. OTR measured at 23° C./50% RH failed as well as the oil and grease resistance measured with chicken fat (60° C.). The substrate was uncalandered and contained no surface size. PPS 1.0 MPa Smoothness was 6.23 um (top side).

Two sheets of the barrier substrate containing highly refined cellulose, as described above, was subjected to high RH of 80% after which the sheets were laminated using calender nip at 80° C. and at a nip load of 80 kN/m. The following properties were obtained: Thickness (70 μm), Gurley-Hill value 31 700 s/100 ml, OTR—failed, OGR 45/60 min (2 parallel measurement). Thus, no barrier improvement was seen although some minor increase in oil and grease resistance was measured.

### Comparative Example 2 (Laminate with PVOH Adhesive)

The dry barrier substrate of Comparative Example 1 was coated with 5% PVOH solution giving a coating weight of ca 5 gsm which hence acted as an adhesive between two similar barrier substrates. After wet glue lamination, the sheets were pressed together using a calendered nip at 80° C. and 150 kN/m. A laminate with the following properties were obtained: Grammage: 67.1 g/m², thickness 75 μm, Gurley-Hill 42 300 s/100 ml (Max value), PPS 1.0 MPa 3.29 μm, OTR-Fail, OGR 180 min. As expected, the wet glue lamination of two barrier substrate provides increased barrier properties especially in terms of oil and grease resistance and air permeance. However, gas barrier properties could not be improved.

### Comparative Example 3 (Laminate Barrier Substrate and SC Paper)

The dry barrier substrate of Comparative Example 1 was laminated to 42 g/m² supercalandered (SC) mechanical paper having the following properties: PPS 1.0 smoothness 1.2 μm, and thickness 42 μm, opacity 89%, in a similar manner as in Comparative Example 2, i.e., using PVOH as an adhesive. The amount of PVOH adhesive was about 6-8 gsm. The pressing was done using a couching roll, which was used to treat the laminate 10 times. The obtained laminate had no OTR barrier, whereas OGR was 120 min. The samples had, however, very significant curl.

### Comparative Example 4 (Laminate with PVOH Adhesive)

The dry barrier substrate of Comparative Example 1 was laminated to a base cup stock (paperboard), in a similar manner as described in Comparative Example 3. In this case, the OGR was 32 h and OTR was 633 and 510 cc/m²/day at 23° C./50% RH (two parallel measurements.) This shows that the barrier properties can be improved if using a thicker substrate.

### Comparative Example 5 (Coating)

The dry barrier substrate of Comparative Example 1 described above was only coated with PVOH solution to a coat weight of about 7.5 gsm. The obtained OTR value was 397 cc/m²/day at 23° C./50% RH and OGR was >24 h confirming that the coating on this substrate gave good barrier properties.

### Example 6

This example utilized an MFC suspension comprising 87 wt % MFC (obtained from enzymatically treated pulp which was then further fibrillated to MFC) and 13 wt % sorbitol based on dry content of the MFC suspension. The solids content of the MFC suspension was 3.6 wt %. The MFC suspension was casted onto a metal belt support in order to form a wet MFC layer. The thickness of the casted wet MFC layer was 490-540 μm, the dry grammage was 18-20 g/m², the casting width was 500 mm and the run speed was 3.3 m/min. A paper substrate of the grade Endura MG Kraft 42 g/m² and a Gurley Hill air permeability value of 13 s/100 ml and a Cobb60 water absorption value of 36 g/m² was utilized and a web thereof unwound form a roll and joined with the wet MFC layer by conveying and guiding the paper substrate web onto the wet MFC layer positioned on the metal belt support to form a laminate structure positioned on the metal belt support. When joining the paper substrate web with the wet MFC layer, the wet MFC layer had a dry content of 3.6 wt % and the paper substrate web had a dry content of 92 wt %. The laminate structure was dried by a combination of a hot air impingement drying device, which was positioned on the side of the laminate structure opposite to the metal belt support, steam-heated metal belt support, and infrared dryer, which was positioned on the side of the laminate structure opposite to the metal belt support and downstream the hot air impingement device. The specific drying rate was ~50 kg (H₂O)/m² h. The drying was performed until the dry content of the laminate structure was 90 wt %, whereby a laminate comprising a paper substrate and an MFC layer was formed. Thereafter the laminate was peeled off from the metal belt support. The results of Example 6 are shown in Table 1 below. Two different tests were run; 6:1 and 6:2. In addition, the OTR and WVTR measurements were performed twice in each test.

The OTR and WVTR properties of the laminate demonstrate high oxygen barrier and medium water vapor barrier of the laminate. Bendtsen and PPS smoothness measurements of the outer MFC surface (which was in contact with the metal belt support during formation of the laminate) demonstrate a smooth surface on MFC layer. Scott-Bond and Z-strength values of the laminate demonstrate good adhesion between MFC layer and the paper substrate (i.e., without any adhesive). Overall, the results demonstrate a fully renewable, biodegradable and recyclable packaging product with good barrier properties.

TABLE 1

| Example | 6:1a | 6:1b | 6:2a | 6:2b |
|---|---|---|---|---|
| Total grammage (g/m²) of laminate | 60 | | 62 | |
| Average MFC grammage (g/m²) | 18 | | 20 | |
| Thickness (μm) of laminate | 73 | | 73 | |
| Density (kg/m³) of laminate | 827 | | 802 | |
| OTR, cc/m2/day | 2.23 | 2.23 | 2.05 | 2.23 |
| (23 C./50% RH)) of laminate | | | | |
| WVTR, g/m2/day | 41.7 | 40.1 | 39.9 | 40.9 |
| (23 C./50% RH) of laminate | | | | |

| | | |
|---|---|---|
| Bendtsen roughness | 24.7 | 34.4 |
| (ml/min) of MFC layer | | |
| PPS Smoothness 1.0 Mpa | 0.6 | 0.9 |
| (μm) of MFC layer | | |
| Scott-Bond (J/m²) of laminate | 99.3 | 159.4 |
| Z-strength (kPa) of laminate | 299.9 | 310.2 |

1. A method for producing a laminate (8) comprising a paper substrate and a microfibrillated cellulose (MFC) layer, wherein the method comprises the steps of:
providing an MFC suspension comprising between 50 weight-% to 100 weight-% MFC based on a total dry weight and a suspension medium;
forming a wet MFC layer by casting said MFC suspension on a casting surface of a metal belt support, wherein said formed wet MFC layer has a dry content of 1-40 weight-%, and wherein said wet MFC layer is formed of an amount of said MFC suspension corresponding to a dry grammage of 8-70 g/m²;
providing a paper substrate web, wherein said paper substrate of said paper substrate web has a Gurley Hill air permeability value of less than 10,000 s/100 ml, as measured according to standard ISO 5636-5:2013;
joining said paper substrate web with said wet MFC layer positioned on said casting surface of said metal belt support to form a laminate structure positioned on said casting surface of said metal belt support, wherein said wet MFC layer has a dry content of 1-40 weight-%, and said paper substrate web has a dry content of at least 70 weight-%, when said paper substrate web is joined with said wet MFC layer;
subjecting said laminate structure to water removal to form said laminate comprising said paper substrate and said MFC layer, wherein said formed laminate has an average dry content of at least 80 weight-%, wherein said laminate structure is positioned on said casting surface of said metal belt support during the water removal, wherein the water removal comprises at least one drying step which comprises subjecting said laminate structure to drying by at least one non-contact drying device arranged on a side of the laminate structure opposite the metal belt support and wherein said metal belt support is heated during said at least one drying step, and
separating said laminate from said metal belt support.

2. The method according to claim 1, wherein said MFC suspension further comprises at least one additive selected from a group consisting of: film forming agents, dispersants, plasticizers, softeners, mineral additives, humectants, cross-linkers, light or UV blockers, lubricants, dyes and rheology modifiers.

3. The method according to claim 1, wherein said suspension medium is or comprises water and wherein said MFC suspension further comprises at least one water-soluble additive.

4. The method according to claim 3, wherein said MFC suspension comprises at least one water-soluble additive selected from a group consisting of: polyvinyl alcohol and derivatives and analogues thereof, starch, carboxymethyl cellulose, sorbitol and polyethylene glycol.

5. The method according to claim 1, wherein said MFC suspension is free of retention agents and flocculation agents.

6. The method according to claim 1, wherein said non-contact drying device is selected from a group consisting of: hot gas impingement drying devices, hot steam impingement drying devices, air dryers, microwave drying devices, ultraviolet drying devices, electron beam drying devices, infrared drying devices, and near infrared drying devices.

7. The method according to claim 1, wherein said joining is performed by positioning said paper substrate web on said wet MFC layer positioned on said casting surface of said metal belt support.

8. The method according to claim 7, wherein said metal belt support provided with said wet MFC layer and said paper substrate web downstream of drying by at least one non-contact drying device is guided, at least partly, around a guide roll so as to provide a pressure of said paper substrate web onto said wet MFC layer at said joining.

9. The method according to claim 1, wherein the metal belt support provided with the laminate structure is conveyed through at least one press nip selected from a group consisting of: a press nip positioned upstream said at least one non-contact drying device, a press nip positioned downstream said at least one non-contact drying device, and a press nip positioned between two separate non-contact drying devices.

10. The method according to claim 1, wherein the method is performed without the use of any press nip.

11. The method according to claim 1, wherein said method further comprises a step of:
pre-drying said wet MFC layer positioned on said casting surface of said metal belt support before said step of joining said paper substrate web with said wet MFC layer.

12. The method according to claim 1, wherein said method further comprises a step of:
dewatering said wet MFC layer positioned on said casting surface of said metal belt support before said step of joining said paper substrate web with said wet MFC layer, and wherein said dewatering of said wet MFC layer is performed by applying a press fabric in direct contact with the wet MFC layer and conducting the wet MFC layer, arranged between the press fabric and the metal belt support, through a pressing equipment.

13. The method according to claim 1, wherein said water removal further comprises a step of dewatering said laminate structure positioned on said casting surface of said metal belt support after said step of joining but before said at least one drying step, wherein said dewatering of said laminate structure is performed by:
applying a press fabric in direct contact with the paper substrate web and conducting the laminate structure, arranged between the press fabric and the metal belt support, through a pressing equipment, or
applying a porous wire or a membrane in direct contact with the paper substrate web and conducting the laminate structure, arranged between the porous wire or membrane and the metal belt support, through a vacuum dewatering equipment, in wherein the porous wire or membrane covers one or several vacuum cavities that remove water from the laminate structure.

14. The method according to claim 1, wherein said water removal comprises at least two drying steps and further comprises a step of dewatering said laminate structure positioned on said casting surface of said metal belt support between the at least two drying steps, wherein said dewatering of said laminate structure is performed by:
applying a press fabric in direct contact with the paper substrate web and conducting the laminate structure, arranged between the press fabric and the metal belt support, through a pressing equipment, or
applying a porous wire or a membrane in direct contact with the paper substrate web and conducting the laminate structure, arranged between the porous wire or membrane and the metal belt support, through a vacuum dewatering equipment, in wherein the porous wire or membrane covers one or several vacuum cavities that remove water from the laminate structure.

15. (canceled)

16. The method according to claim 1, wherein said formed wet MFC layer comprises a single layer or two or more web layers formed on top of each other.

17. (canceled)

18. The method according to claim 1, wherein said laminate has an oxygen transmission rate (OTR), measured according to the standard ASTM F1927-20 at 50% relative humidity and 23° C., of less than 15 cc/m²/24 h.

19. The method according to claim 1s, wherein said laminate has a water vapor transmission rate, measured according to the standard ASTM F1249-20 at 50% relative humidity and 23° C., of less than 100 g/m²/24 h.

20. A laminate comprising:
a paper substrate and a microfibrillated cellulose (MFC) layer, obtained by the method of claim 1.

21. A laminate comprising:
a paper substrate and a microfibrillated cellulose (MFC) layer,
wherein said MFC layer comprises between 50 weight-% to 100 weight-% MFC based on a total dry weight, has a dry grammage of 8-70 g/m² and has an average dry content of at least 80 weight-%, wherein the laminate has no lamination adhesive or tie layer between the paper substrate and the MFC layer.

22. The laminate according to claim 21, wherein said laminate has a Scott Bond value of >50 J/m², as measured with TAPPI 569.

23. The laminate according to claim 21, wherein said laminate has a Z-strength value of >200 kPa, as measured with TAPPI 541.

24. A packaging material comprising:
the laminate according to claim 21.

25. (canceled)
